(19) United States
(12) Patent Application Publication
(10) Pub. No.: US 2025/0157442 A1
(43) Pub. Date: May 15, 2025

(54) AUTOMATIC PLAYING PIANO, AUTOMATIC PLAYING METHOD AND NON-TRANSITORY COMPUTER-READABLE STORAGE MEDIUM

(71) Applicant: YAMAHA CORPORATION, Hamamatsu-shi (JP)

(72) Inventor: Jun ISHII, Hamamatsu-shi (JP)

(21) Appl. No.: 19/024,332

(22) Filed: Jan. 16, 2025

Related U.S. Application Data
(63) Continuation of application No. PCT/JP2023/024234, filed on Jun. 29, 2023.

(30) Foreign Application Priority Data
Aug. 12, 2022 (JP) 2022-129057

(51) Int. Cl. G10H 1/00; G10F 1/02

(52) U.S. Cl. CPC G10H 1/0025; G10F 1/02

(57) ABSTRACT

An automatic playing piano 100 configured to executes a musical performance by driving a key 1 based on musical playing information MP, the automatic playing piano 100 includes a controller including a memory storing instructions and a processor that implements the instructions to: set an adjustment time AT for adjusting a timing of driving the keys to correct a discrepancy in sound generation timing due to an operation delay time from receiving an instruction to play one sound specified by the musical playing information MP to generating the one sound by driving one of the keys, and convert an intensity of each sound specified by the musical playing information MP according to the set adjustment time AT set.

### CROSS-REFERENCE TO RELATED APPLICATIONS

This application is a Continuation of International Patent Application No. PCT/JP2023/024234, filed on Jun. 29, 2023, which claims the benefit of priority to Japanese Patent Application No. 2022-129057, filed on Aug. 12, 2022, the entire contents of which are incorporated herein by reference.

### FIELD

The present invention relates to a piano with an automatic playing function.

### BACKGROUND

For example, as disclosed in JP Patent No. 4479554, there is an automatic playing piano that executes a musical performance by driving a key based on musical playing information. In the automatic playing piano, a key depression operation is performed by driving a solenoid based on the musical playing information. The hammer then performs a striking operation by the key depression operation, and a musical sound is generated.

In addition, a system for performing a session using two remotely located, networked, automatic playing pianos is disclosed in JP Patent No. 5338247.

### SUMMARY

According to an embodiment of the present invention, an automatic playing piano configured to executes a musical performance by driving keys based on musical playing information is provided. The automatic playing piano comprises controller including a memory storing instructions and a processor that implements the instructions to: set an adjustment time for adjusting a timing of driving the keys to correct a discrepancy in sound generation timing due to an operation delay time from receiving an instruction to play one sound specified by the musical playing information to generating the one sound by driving one of the keys, and convert an intensity of each sound specified by the musical playing information according to the set adjustment time.

According to an embodiment of the present invention, an automatic playing method of executing a musical performance by driving keys of an automatic playing piano based on musical playing information is provided. The automatic playing method comprises setting an adjustment time for adjusting a timing of driving the keys to correct a discrepancy in sound generation timing due to an operation delay time from receiving an instruction to play one sound specified by the musical playing information to generating the one sound by driving one of the keys, and converting an intensity of each sound specified by the musical playing information according to the set adjustment time.

According to an embodiment of the present invention, a non-transitory computer-readable storage medium storing a program executable by a computer to execute an automatic playing method of executing a musical performance by driving keys of an automatic playing piano based on musical playing information, the automatic playing method comprising: setting an adjustment time for a timing of driving the keys to correct adjusting a discrepancy in sound generation timing due to an operation delay time from receiving an instruction to play one sound specified by the musical playing information to generating the one sound by driving one of the keys; and converting an intensity of each sound specified by the musical playing information according to the set adjustment time is provided.

### BRIEF DESCRIPTION OF DRAWINGS

FIG. 1 is a configuration diagram of an automatic playing piano according to an embodiment.

FIG. 2 is a system block diagram of an automatic playing piano.

FIG. 3 is a diagram showing a data format of musical playing information.

FIG. 4 is a diagram showing an example of an intensity-operation delay time table.

FIG. 5 is a diagram showing an example of an intensity conversion table.

FIG. 6 is a functional block diagram of a controller included in an automatic playing piano.

FIG. 7 is a diagram showing a relationship between an input intensity and an output intensity and a relationship between an input intensity and an excess delay time in the case where intensity conversion is not performed.

FIG. 8 is a diagram showing a relationship between an input intensity and an output intensity and a relationship between an input intensity and an excess delay time in the case where intensity conversion is performed.

FIG. 9 is a flowchart showing an automatic playing method according to an embodiment.

FIG. 10 is a diagram showing a relationship between an input intensity and an output intensity and a relationship between an input intensity and an excess delay time in the case where intensity conversion is performed, according to another embodiment.

### DESCRIPTION OF EMBODIMENTS

As described above, in an automatic playing piano, a musical playing information is input and then the musical sound is generated through a mechanical operation, so that an operation delay time occurs. Therefore, in the automatic playing piano, an adjustment time for adjusting the operation delay time from receiving a musical playing instruction based on the musical playing information to generating a sound is set. A user who uses the automatic playing system desires to shorten the adjustment time. For example, in a system using the automatic playing piano at a remote location connected by a network, it is expected that the value of the automatic playing piano is further improved by shortening the adjustment time.

In the above-mentioned JP Patent No. 4479554, a table in which an intensity (velocity) specified by MIDI (the musical playing information) is associated with a drive instruction value of a solenoid is created for each musical instrument. However, in JP Patent No. 4479554, it is difficult to satisfy a recent demand for shortening the adjustment time.

According to the present invention, it is possible to provide an automatic playing piano that can shorten the adjustment time without deteriorating the quality of the musical sound.

Hereinafter, an automatic playing piano, an automatic playing method, and a non-transitory computer-readable storage medium storing an automatic playing program according to an embodiment of the present invention will be described with reference to the accompanying drawings.

### 1. OVERALL CONFIGURATION OF AUTOMATIC PLAYING

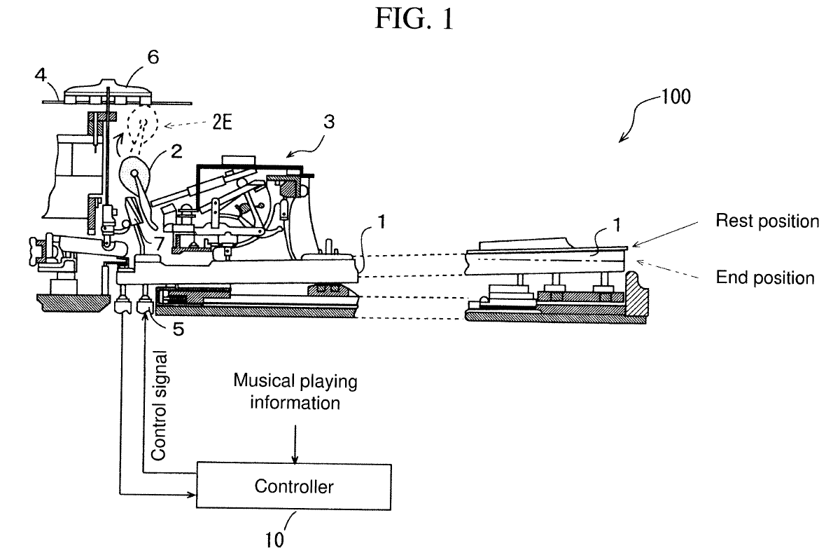

FIG. 1 is a configuration diagram of an automatic playing piano 100 according to the present embodiment. FIG. 1 shows a side view (partially cross-sectional view) of a mechanical sound generation mechanism (a sound generation mechanism corresponding to one key) of the automatic playing piano 100. In the following description, a key 1 side in FIG. 1 will be described as the front side of the automatic playing piano 100 (the player side), and an action mechanism 3 side in FIG. 1 will be described as the rear side of the automatic playing piano 100.

As shown in FIG. 1, the automatic playing piano 100 includes the key 1, the action mechanism 3 that transmits the movement of the key 1 to a hammer 2, a string 4 struck by a striking movement of the hammer 2, a solenoid 5 for driving the key 1, and a damper 6 for stopping an oscillation of the string 4. These components are arranged corresponding to each of a plurality of keys (for example, 88 keys) of the piano.

The automatic playing piano 100 has an automatic playing function of generating a musical sound by driving the solenoid 5, but it can also be played by a player by pressing the key 1, like a normal acoustic piano. The mechanical operations at the time of non-depression and at the time of depression described below correspond to the operations at the time of automatic playing and at the time of playing by the performer. At the time of non-depression, the key 1 is at a rest position (a position at stroke amount of 0 mm) indicated by a solid line in FIG. 1. The key 1 is depressed from the rest position to an end position in response to the key depression operation (an operation of depressing the right side of the key 1 in FIG. 1). In FIG. 1, the end position of the key 1 is indicated by a two-dot chain line. When the key 1 is depressed, the operation of the action mechanism 3 causes the hammer 2 to rotate to a striking position 2E (position indicated by a dotted line in FIG. 1) and the damper 6 to move upward from the string 4 to release the string 4. When the hammer 2 strikes the released string 4, a sound corresponding to the depressed key 1 is generated. In addition, a backcheck 7 is a member for preventing rebound of the hammer 2 due to the reaction when striking the string.

Next, an operation specific to the automatic playing will be described. The solenoid 5 is arranged at the lower rear end of the corresponding key 1, and is driven based on a control signal supplied from a controller 10. In response to the driving of the solenoid 5, a plunger part protrudes in an axial direction (upward) to push up the rear end of the corresponding key 1. The key 1 is depressed by a push-up operation by the plunger. As a result, the string is struck by the hammer 2 by a similar operation as described above. Furthermore, in the example of FIG. 1, the solenoid 5 includes a speed sensor for detecting an operating speed of the plunger, and the output of the sensor is fed back as a feedback signal to the controller 10.

### 2. SYSTEM CONFIGURATION

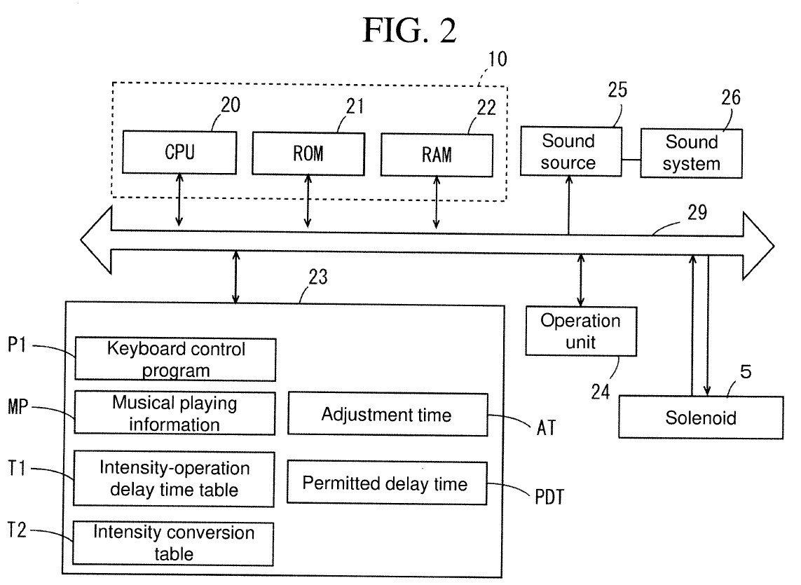

FIG. 2 is a block diagram showing a configuration of a computer system including the controller 10 included in the automatic playing piano 100 shown in FIG. 1. As shown in FIG. 2, the automatic playing piano 100 includes a CPU 20, a ROM 21, a RAM 22, a storage device 23, an operation unit 24, a sound source 25, and a sound system 26. These devices are connected via a system bus 29. The solenoid 5 is connected to the system bus 29 via a PWM generator (not shown).

The CPU 20 controls the overall operation of the automatic playing piano 100. The ROM 21 stores a control program executed by the CPU 20 and various types of data. The RAM 22 is used as a work area of the CPU 20. The storage device 23 stores a keyboard control program P1, a musical playing information MP, an intensity-operation delay time table T1, an intensity conversion table T2, an adjustment time AT, and a permitted delay time PDT. The storage device 23 can be configured by various storage media such as a hard disk and a semiconductor memory. The keyboard control program P1 performs a process of setting the adjustment time AT for adjusting a discrepancy in the sound generation timing in the automatic playing function, a process of converting the intensity of each sound specified by the musical playing information MP according to the adjustment time AT, and the like. The contents of each of the data MP, T1, T2, AT, and PDT will be described later.

The operation unit 24 is an interface for the user to perform various operations (start, stop, song selection, and the like) related to the automatic playing. The sound source 25 and the sound system 26 are functional units for directly reproducing the musical playing information MP regardless of the oscillation of the string 4. A control signal for driving the solenoid generated in the CPU 20 is converted into a PWM signal via the PWM generator (not shown) and supplied to the solenoid 5. The driving amount of the solenoid 5 is controlled depending on a pulse width of the supplied PWM signal.

### 3. ADJUSTMENT TIME AT AND PERMITTED DELAY TIME PDT

During automatic playing, the CPU 20 supplies the control signal to the solenoid 5 based on the musical playing information MP. When the solenoid 5 is driven in response to the control signal, the key 1 is depressed, the action mechanism 3 is operated, and the hammer 2 strikes the string 4. As a result, a sound based on the musical playing information MP is generated. As described above, an operation delay time due to the operation of various mechanisms occurs in the automatic playing piano 100 from the time when a musical playing instruction based on the musical playing information MP is received from the CPU 20 to the time when the sound is actually generated. This operation delay time varies depending on the intensity (velocity) of each sound specified by the musical playing information MP. Since the hammer 2 needs to strike the string 4 strongly in order to generate a strong sound, a control signal for operating the solenoid 5 at a high speed is supplied to the solenoid 5. On the other hand, in order to generate a low-intensity sound, a control signal for operating the solenoid 5 at a low speed is supplied to the solenoid 5. Therefore, the operation delay time of the low-intensity sound is longer than that of the high-intensity sound.

Therefore, the adjustment time AT for adjusting the discrepancy in the sound generation timing by the automatic playing is set. For example, when the adjustment time AT is 0.5 s, the CPU 20 adjusts the timing of supplying the control signal so that a sound is generated after 0.5 s after inputting the data of each sound recorded in the musical playing information MP. Alternatively, in the case where the musical playing information MP is received through the network, the CPU 20 adjusts the timing of supplying the control signal so that a sound is generated after 0.5 s after receiving data of each sound recorded in the musical playing information MP. That is, the control signal is supplied to the solenoid 5 at an earlier timing for the low-intensity sound, and the control signal is supplied to the solenoid 5 at a later timing for the high-intensity sound, thereby adjusting the sound generation timing of each sound. In other words, the adjustment time AT is a time that is a target of the sound generation timing of each sound. The adjustment time AT is set by the user and stored in the storage device 23.

Recently, there is a need for a user to shorten the adjustment time AT. Therefore, the keyboard control program P1 of the present embodiment realizes the shortening of the adjustment time AT by performing a conversion to push up the intensity of the low-intensity sound. In the automatic playing piano 100 of the present embodiment, the permitted delay time PDT is further set. The permitted delay time PDT is the time allowed to generate a sound over the adjustment time AT. The keyboard control program P1 performs a conversion to push up the intensity of the low-intensity sound so that it falls within the permitted delay time PDT, which is slightly delayed from the adjustment time AT. Therefore, it is possible to avoid a large conversion amount of a very low-intensity sound to maintain the adjustment time AT. That is, for the low-intensity sound, the adjustment time AT can be shortened while avoiding deterioration in the quality of the musical sound.

### 4. TABLE

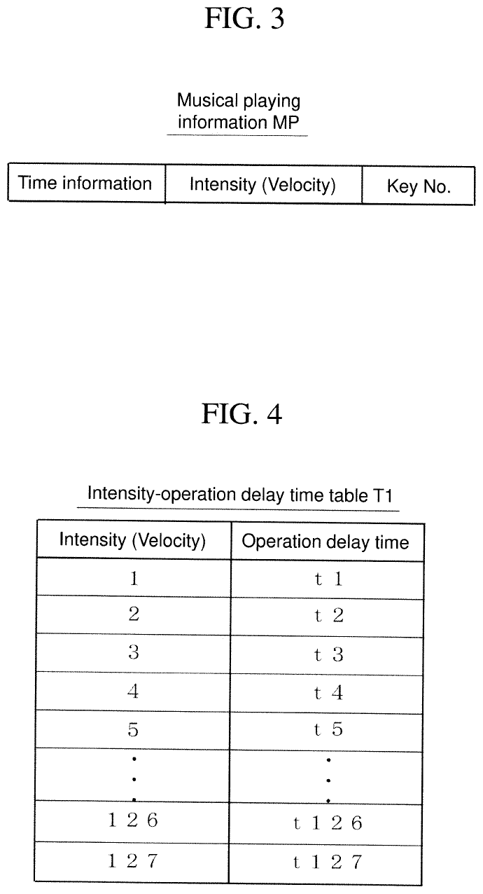

FIG. 3 is a diagram showing a data format of the musical playing information MP. In the present embodiment, an SMF format is used as the musical playing information MP. Time information, intensity (velocity), and a key number No are recorded in in the musical playing information MP. The key number No is information for specifying the key 1 to be reproduced, and is a unique number No assigned to each of the keys 1 (for example, 88 keys) included in the automatic playing piano 100. The intensity is information corresponding to the speed of the hammer 2 for realizing the striking operation, and indicates the volume of the sound to be generated. In the musical playing information MP, the key number No and the intensity are recorded in association with each time information.

FIG. 4 is a diagram showing an example of the intensity-operation delay time table T1. The intensity-operating delay time table T1 records the correspondence between the intensity (velocity) and the operation delay time. As described above, the operation delay time from receiving the musical playing instruction based on the musical playing information MP from the CPU 20 to the time when the sound is actually generated varies depending on the intensity of the sound recorded in the musical playing information MP. The operation delay time corresponding to all the intensities is recorded in the intensity-operation delay time table T1. In the example of FIG. 4, an operation delay time t1 to an operation delay time t127 corresponding to the lowest intensity 1 to the highest intensity 127, are recorded.

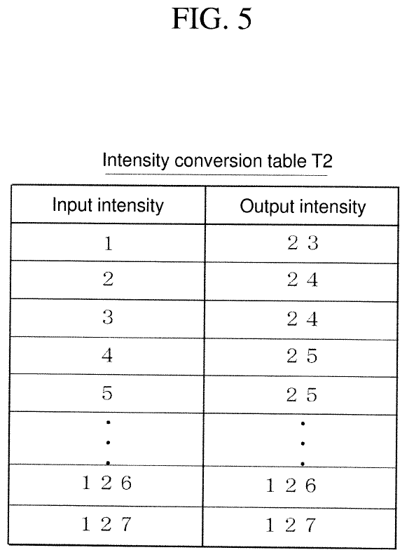

FIG. 5 is a diagram showing an example of the intensity conversion table T2. The intensity conversion table T2 is a table for converting the intensity specified by the musical playing information MP. The keyboard control program P1 realizes the shortening of the adjustment time AT by performing a conversion of pushing up the intensity of the low-intensity sound based on the intensity conversion table T2. In the example of FIG. 5, corresponding output intensities are recorded for input intensities from the lowest intensity 1 to the highest intensity 127. For example, in the example of FIG. 5, the input intensity of the lowest intensity 1 is pushed up to an intensity 23. A method for generating the intensity conversion table T2 will be described later.

### 5. CONTROLLER CONFIGURATION

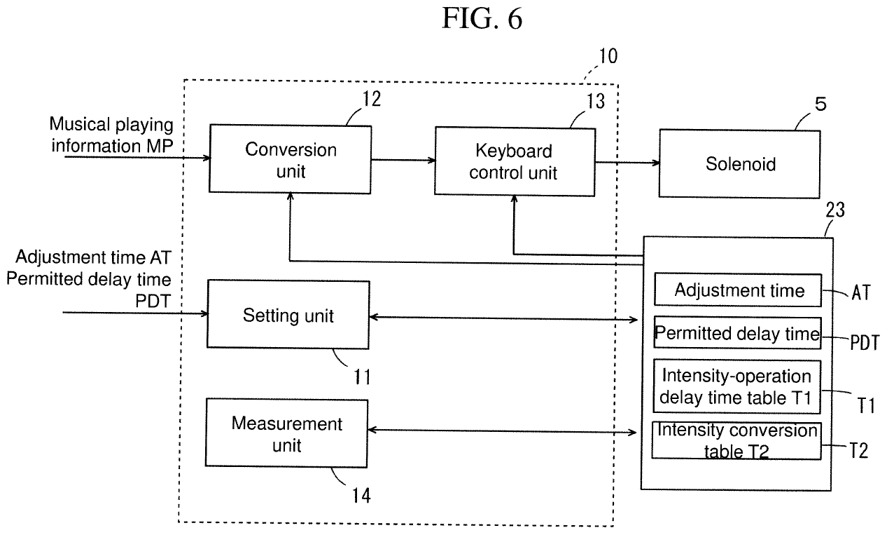

FIG. 6 is a functional block diagram showing a configuration of the controller 10. As shown in FIG. 6, the controller 10 includes a setting unit 11, a conversion unit 12, a keyboard control unit 13, and a measurement unit 14. The setting unit 11, the conversion unit 12, the keyboard control unit 13, and the measurement unit 14 are functional units realized by executing the keyboard control program P1 on the CPU 20 while using the RAM 22 as the work area. In other words, the setting unit 11, the conversion unit 12, the keyboard control unit 13, and the measurement unit 14 are functional units included in the CPU 20.

The setting unit 11 stores the adjustment time AT and the permitted delay time PDT in the storage device 23. The setting unit 11 records the adjustment time AT and the permitted delay time PDT based on a setting operation by the user using the operation unit 24. The conversion unit 12 converts the intensities of the sounds recorded in the musical playing information MP based on the intensity conversion table T2. The keyboard control unit 13 supplies the control signal to the solenoid 5 while adjusting the sound generation timing based on the converted musical playing information MP and the intensity-operation delay time table T1 received from the conversion unit 12.

The measurement unit 14 executes a measurement process for generating the intensity-operation delay time table T1. The measurement unit 14 generates the intensity-operation delay time table T1 by measuring a time from when the CPU 20 gives a musical playing instruction for one sound included in the musical playing information MP until when the hammer 2 operates and actually generates the one sound. The measurement unit 14 measures the operation delay time for all the intensities until generating a sound while the conversion process in the conversion unit 12 is turned off. For example, the measurement process by the measurement unit 14 is performed before shipment from the factory. Alternatively, the user may execute the measurement process at an arbitrary timing. The measurement unit 14 stores the generated intensity-operation delay time table T1 in the storage device 23.

The case where the keyboard control program P1 is stored in the storage device 23 is described as an example. In another embodiment, the keyboard control program P1 may be stored in a storage medium such as a semiconductor memory or a DVD. The CPU 20 may access the storage medium via a device interface and store the keyboard control program P1 stored in the storage medium in the storage device 23 or the ROM 21. Alternatively, the CPU 20 may access the storage medium via the device interface and execute the keyboard control program P1 stored in the storage medium. Alternatively, the CPU 20 may download the keyboard control program P1 from a server on the network via the communication interface, and store the downloaded keyboard control program P1 in the storage device 23 or the ROM 21.

### 6. METHOD FOR GENERATING INTENSITY CONVERSION TABLE T2

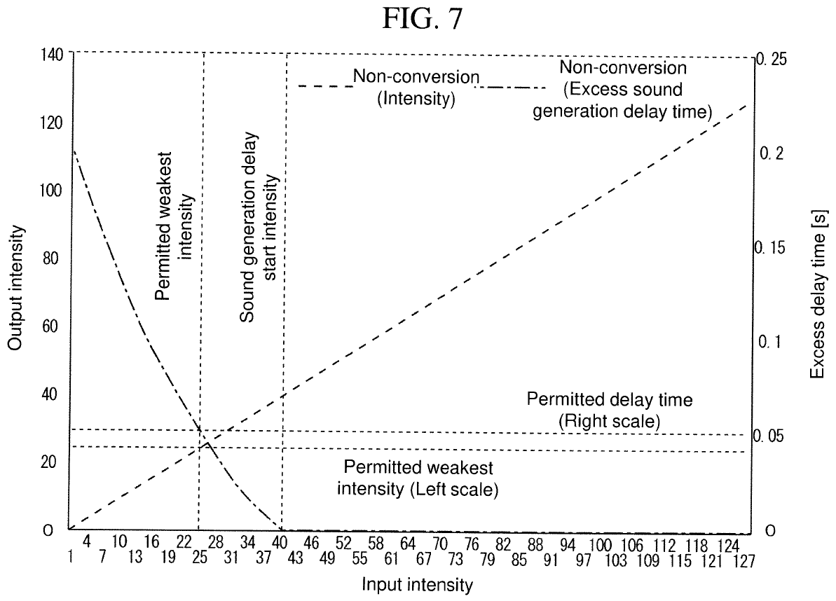

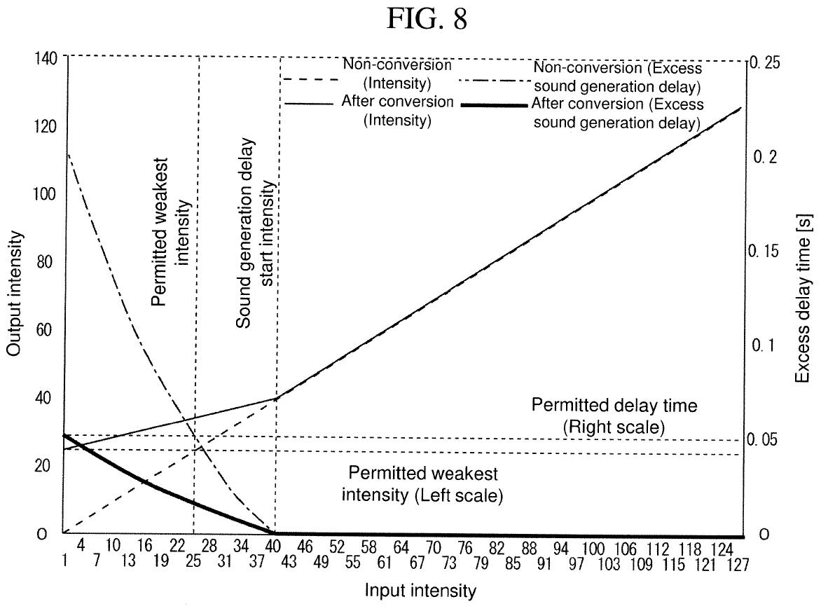

Next, the method for generating the intensity conversion table T2 will be described. The setting unit 11 generates the intensity conversion table T2 as shown in FIG. 5 based on the adjustment time AT and the permitted delay time PDT. FIG. 7 and FIG. 8 are diagrams for explaining the method for generating the intensity conversion table T2.

In FIG. 7 and FIG. 8, the horizontal axis represents the input intensity of the musical playing information MP, and the left vertical axis represents the output intensity of the musical playing information MP, that is, the intensity after the conversion by the conversion unit 12. In addition, the right vertical axis indicates an excess delay time relative to the adjustment time AT. The input and output intensities are integer values from the lowest intensity 1 to the highest intensity 127. FIG. 7 shows a graph in the case where the conversion by the conversion unit 12 is not performed. That is, the input intensity is directly output as the output intensity. In this case, in the example shown in the figure, when the input intensity is less than 40, the operation delay time exceeds the adjustment time AT. That is, the excess delay time occurs in the low-intensity sounds from the input intensity 1 to the input intensity 40. From this relationship, the setting unit 11 obtains the input intensity 40 as the sound generation delay start intensity.

In addition, the setting unit 11 obtains the permitted weakest intensity based on the permitted delay time PDT. The permitted weakest intensity is the weakest intensity in which the excess delay time falls within the permitted delay time PDT. In the example of FIG. 7, for example, when the permitted delay time PDT is 0.05 s, the permitted weakest intensity is around the intensity 25. Therefore, the setting unit 11 generates the intensity conversion table T2 as shown in the graph of FIG. 8. The setting unit 11 pushes the intensity 1, which is the weakest intensity, up to the permitted weakest intensity (25 in the example of the drawing). After that, the intensity conversion table T2 is generated by linearly interpolating between the permitted weakest intensity 25 from the sound generation delay start intensity 40. As a result, the curve of the excess delay time after the conversion becomes as shown in FIG. 8, and the excess delay time falls within the permitted delay time PDT (0.05 s in the example of the drawing) even at the intensity 1 which is the weakest intensity.

### 7. AUTOMATIC PLAYING METHOD

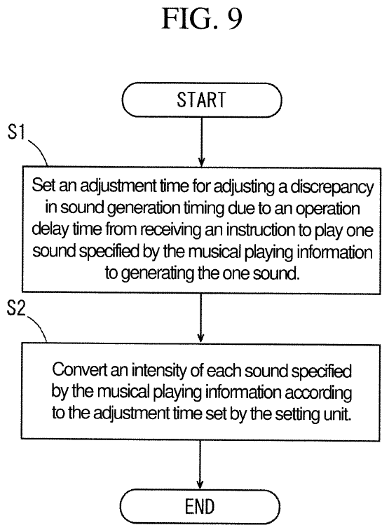

Next, the automatic playing method according to the present embodiment will be described with reference to the flowchart of FIG. 9. The automatic playing method is performed by executing the keyboard control program P1 on the CPU 20.

### Step S1

In step S1, the setting unit 11 sets the adjustment time AT for adjusting the discrepancy in the sound generation timing due to the operation delay time from receiving an instruction to play one sound specified by the musical playing information MP to generating the one sound. As described above, the adjustment time AT is set by a user operation. For example, the user sets a time such as 0.1 s, 0.2 s as the adjustment time AT. In addition, the setting unit 11 sets the permitted delay time PDT. The permitted delay time PDT is set by the user operation. For example, the user sets a time such as 0.1 s, 0.05 s as the permitted delay time PDT. The setting unit 11 stores the adjustment time AT and the permitted delay time PDT in the storage device 23.

### Step S2

In step S2, the conversion unit 12 converts the intensity of each sound specified by the musical playing information MP according to the adjustment time AT set by the setting unit 11. That is, the conversion unit 12 converts the intensity of each sound specified by the musical playing information MP based on the intensity conversion table T2. Since the intensity conversion table T2 is generated based on the adjustment time AT and the permitted delay time PDT, a relatively strong sound among the sounds specified by the musical playing information MP is generated according to the adjustment time AT. On the other hand, in the case where the excess delay time does not occur, the low-intensity sounds among the sounds specified by the musical playing information MP are generated according to the adjustment time AT. The sound in which the excess delay time occurs is generated slightly later than the adjustment time AT within the range of the permitted delay time PDT.

### 8. FEATURES AND EFFECTS OF THE EMBODIMENT

As described above, the automatic playing piano 100 according to the present embodiment is the automatic playing piano 100 that executes a musical performance by driving the key 1 based on the musical playing information MP. The automatic playing piano 100 includes the setting unit 11 configured to set the adjustment time AT for adjusting the discrepancy in the sound generation timing due to the operation delay time from receiving an instruction to play one sound specified by the musical playing information MP to generating the one sound, and the conversion unit 12 configured to convert the intensity of each sound specified by the musical playing information MP according to the adjustment time AT set in the setting unit 11.

The automatic playing piano 100 of this embodiment can convert the intensity of the sound specified by the playing information MP according to the set adjustment time AT. For example, in the case where the adjustment time AT is set to be short, a conversion such as pushing up a sound with a small volume is performed accordingly. According to this embodiment, it is possible to provide the automatic playing piano 100 that can shorten the adjustment time AT without deteriorating the quality of the musical sound.

In the automatic playing piano 100 of the present embodiment, the conversion unit 12 may convert the intensity of each sound in which the operation delay time exceeds the adjustment time AT so that the intensity is greater than the intensity specified by the musical playing information MP.

In this case, the low-intensity sound can also be generated according to the adjustment time AT.

In the automatic playing piano 100 of the present embodiment, the setting unit 11 may set the permitted delay time PDT for the adjustment time AT when the operation delay time is allowed to exceed the adjustment time AT, and the conversion unit 12 may convert the intensity of each sound specified by the musical playing information MP according to the adjustment time AT and the permitted delay time PDT.

In this case, the intensity of the sound specified by the musical playing information MP can be converted according to the set adjustment time AT and the permitted delay time PDT. Since it is allowed to generate a sound delayed relative to the adjustment time AT, it is possible to prevent an excessive conversion from being performed on the low-intensity sound, and to improve the quality of the musical sound while shortening the adjustment time AT.

### 9. MODIFICATIONS

### First Modification

In the above-described embodiment, the adjustment time AT and the permitted delay time PDT are set, but the permitted delay time PDT may not be set. In this case, the setting unit 11 generates the intensity conversion table T2 based on the adjustment time AT. According to the intensity conversion table T2, the intensity of the low-intensity sound is pushed up, and the sound of all intensities are converted so as to fall within the adjustment time AT. As a result, the adjustment time AT can be reduced.

### Second Modification

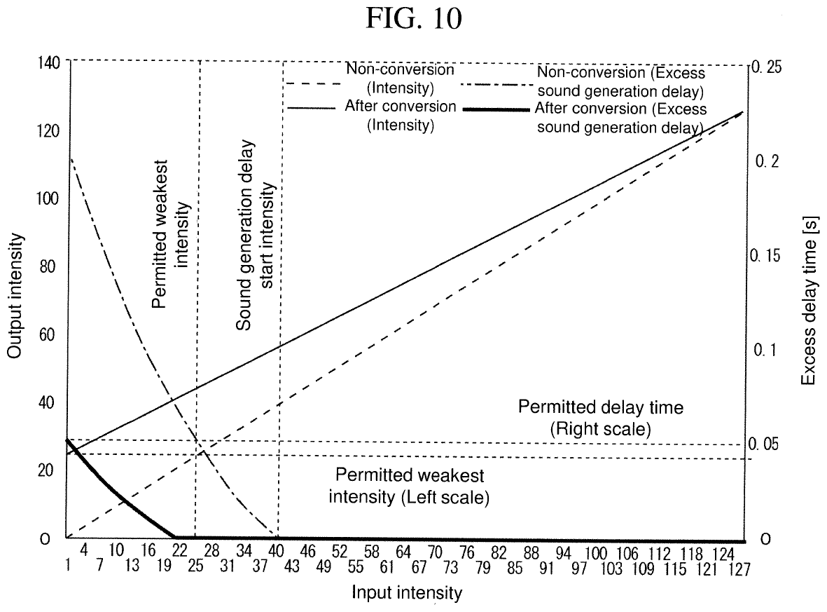

In the above-described embodiment, as shown in FIG. 8, the conversion unit 12 pushes up the intensity of the smallest sound to the permitted weakest intensity, and converts the intensity of each sound specified by the musical playing information MP so as to linearly interpolate between the pushed-up permitted weakest intensity and the sound generation delay start intensity. As a modification, as shown in FIG. 10, the conversion unit 12 may push up the intensity of the smallest sound to the permitted weakest intensity and convert the intensity of each sound specified by the musical playing information MP so as to linearly interpolate between the pushed-up permitted weakest intensity and the highest intensity. In the examples shown in FIG. 8 and FIG. 10, the conversion by linear interpolation is performed, but the interpolation may be performed by a curve.

What is claimed is:

1. An automatic playing piano configured to executes a musical performance by driving keys based on musical playing information, the automatic playing piano comprising:
a controller including a memory storing instructions and a processor that implements the instructions to:
set an adjustment time for adjusting a timing of driving the keys to correct a discrepancy in sound generation timing due to an operation delay time from receiving an instruction to play one sound specified by the musical playing information to generating the one sound by driving one of the keys; and
convert an intensity of each sound specified by the musical playing information according to the set adjustment time.

2. The automatic playing piano according to claim 1, wherein the controller converts the intensity of each sound so that the intensity is greater than an intensity specified by the musical playing information for each sound in which the operation delay time exceeds the adjustment time.

3. The automatic playing piano according to claim 1, wherein the controller:
sets a permitted delay time for the adjustment time when the operation delay time is allowed to exceed the adjustment time, and
converts the intensity of each sound specified by the musical playing information according to the adjustment time and the permitted delay time.

4. The automatic playing piano according to claim 3, wherein the controller converts the intensity of each sound so that the intensity is greater than an intensity specified by the musical playing information for each sound in which the operation delay time exceeds a sum of the adjustment time and the permitted delay time.

5. The automatic playing piano according to claim 3, wherein the controller converts the intensity of each sound specified by the musical playing information so that the operation delay time from receiving an instruction to play a sound with a lowest intensity to generating the sound with the lowest intensity does not exceed the permitted delay time.

6. The automatic playing piano according to claim 3, wherein
the controller converts an intensity of the weakest sound to a permitted weakest intensity and to convert the intensity of each sound specified by the musical playing information to linearly interpolate between the permitted weakest intensity and a sound generation delay start intensity,
the permitted weakest intensity is at which the operation delay time until a sound is generated is equal to the permitted delay time, and
the sound generation delay start intensity is at which the operation delay time until a sound is generated is equal to the adjustment time.

7. The automatic playing piano according to claim 3, wherein:
the controller converts an intensity of the weakest sound to a permitted weakest intensity and to convert the intensity of each sound specified by the musical playing information to linearly interpolate between the permitted weakest intensity and a highest intensity, and
the permitted weakest intensity is at which the operation delay time until a sound is generated is equal to the permitted delay time.

8. An automatic playing method of executing a musical performance by driving keys of an automatic playing piano based on musical playing information, the automatic playing method comprising:
setting an adjustment time for adjusting a timing of driving the keys to correct a discrepancy in sound generation timing due to an operation delay time from receiving an instruction to play one sound specified by the musical playing information to generating the one sound by driving one of the keys; and
converting an intensity of each sound specified by the musical playing information according to the set adjustment time.

9. A non-transitory computer-readable storage medium storing a program executable by a computer to execute an automatic playing method of executing a musical performance by driving keys of an automatic playing piano based on musical playing information, the automatic playing method comprising:
setting an adjustment time for adjusting a timing of driving the keys to correct a discrepancy in sound generation timing due to an operation delay time from receiving an instruction to play one sound specified by the musical playing information to generating the one sound by driving one of the keys; and
converting an intensity of each sound specified by the musical playing information according to the set adjustment time.
